(19) United States
(12) Patent Application Publication
(10) Pub. No.: US 2018/0052255 A1
(43) Pub. Date: Feb. 22, 2018

(54) OPTICAL-FILM WOUND BODY, METHOD FOR STORING THE SAME, AND METHOD FOR MANUFACTURING BASE FILM/POLARIZING PLATE LAMINATE

(71) Applicant: ZEON CORPORATION, Chiyoda-ku, Tokyo (JP)

(72) Inventor: Mana SHIMODE, Tokyo (JP)

(73) Assignee: ZEON CORPORATION, Chiyoda-ku, Tokyo (JP)

(21) Appl. No.: 15/560,239

(22) PCT Filed: Mar. 9, 2016
(86) PCT No.: PCT/JP2016/057475

§ 371 Date: Sep. 21, 2017

(30) Foreign Application Priority Data
Mar. 30, 2015 (JP) 2015-069075

(51) Int. Cl. G02B 1/14; B32B 27/32; B32B 37/14

(52) U.S. Cl. CPC G02B 1/14; B32B 27/32; G02B 5/30; B32B 2307/42; B32B 2307/51; B32B 37/14

(57) ABSTRACT

An optical-film wound body of a long-length optical film, formed by winding a substrate film/masking film stacked body with a length of 1,000 m or more, the substrate film/masking film stacked body being formed by stacking a substrate film and a masking film, wherein the masking film is formed of a material having a melting peak of 25° C. or higher and 70° C. or lower, and a peel strength of the substrate film with a polarizing plate at an inner wound portion and that at an outer wound portion satisfy a specific relationship; a method for storing the wound body; and a method for producing a substrate film/polarizing plate stacked body.

### FIELD

The present invention relates to an optical-film wound body, a method for storing the same, and a method for producing a substrate film/polarizing plate stacked body.

### BACKGROUND

In prior art, there has been commonly practiced to produce an optical film for use as a component of an optical device by using a resin as a material and to attach the optical film to a different film to form a stacked body. For example, a polarizing plate/substrate film stacked body including a polarizing plate and a substrate film has been produced by preparing a substrate film and further attaching the substrate film to a polarizing plate.

Such a substrate film is often mass-produced as a long-length film prior to the production of a stacked body for improving the production efficiency. Since the mass-produced substrate film needs to be stored over a long period of time and to be transported, the substrate film is often wound to form a wound body, which is suitable for storage and transportation. As an example substrate film wound body, there is known a wound body produced by winding a substrate film/masking film stacked body in which a substrate film and a masking film are stacked (for example, Patent Literature 1).

### CITATION LIST

### Patent Literature

Patent Literature 1: Japanese Patent Application Laid-Open No. 2013-047000 A

### SUMMARY

### Technical Problem

The quality of a substrate film wound body may be degraded by storage for a long period of time. For example, when the wound body is stored for a long period of time and then the substrate film is attached to a polarizing plate to form a polarizing plate/substrate film stacked body, the stacked body may have insufficient peel strength.

The surface of the masking film opposite to the surface to be attached to the substrate film is usually a rough surface for preventing blocking. The storage of the wound body for a long period of time may cause a phenomenon called “texture transfer” in which the surface roughness on the masking film is transferred to an optical film. This phenomenon may degrade the quality of the surface of the substrate film.

Thus, an object of the present invention is to provide an optical-film wound body and a method for storing the optical-film wound body that can provide high peel strength with a polarizing plate and maintain high surface quality even after storage for a long period of time.

A further object of the present invention is to provide a method for producing a substrate film/polarizing plate stacked body by which a substrate film/polarizing plate stacked body having high peel strength and high surface quality can be efficiently produced.

### Solution to Problem

The inventor of the present invention has conducted studies to solve the aforementioned issues. As a result, the inventor has found that, when a masking film having a specific melting peak is used, occurrence of texture transfer can be reduced although the peel strength with a polarizing plate after storage for a long period of time tends to be reduced. The inventor also has found that such reduction of the peel strength is remarkable in an inner wound portion of the wound body rather than in an outer wound portion. The inventor has further conducted studies in this regard and has found that the peel strength of a wound body having such a masking film is less reduced when the wound body is stored under specific storage conditions and, as a result, maintenance of both peel strength and surface quality can be achieved, completing the present invention.

The present invention thus provides the following:

(1) An optical-film wound body of a long-length optical film, formed by winding a substrate film/masking film stacked body with a length of 1,000 m or more, the substrate film/masking film stacked body being formed by stacking a substrate film and a masking film, wherein

the masking film is formed of a material having a melting peak of 25° C. or higher and 70° C. or lower, and

a peel strength Fi and a peel strength Fo satisfy a relationship of Fi/Fo≧0.3, where
Fi represents a peel strength obtained in a case where a surface of the substrate film corresponding to the substrate film/masking film stacked body at an inner wound portion of the optical-film wound body, the surface being opposite to a surface attached to the masking film, is attached to a polarizing plate, and
Fo represents a peel strength obtained in a case where a surface of the substrate film corresponding to the substrate film/masking film stacked body at an outer wound portion of the optical-film wound body, the surface being opposite to a surface attached to the masking film, is attached to a polarizing plate.

(2) The optical-film wound body according to (1), wherein a larger one of the peel strength Fi and the peel strength Fo is 1 to 10 N/15 mm.

(3) The optical-film wound body according to (1) or (2), wherein the substrate film of the wound body is a stretched film.

(4) The optical-film wound body according to any one of (1) to (3), wherein the substrate film is a film made of a resin containing an alicyclic structure-containing polymer.

(5) The optical-film wound body according to any one of (1) to (4), wherein the masking film is a film made of polyethylene.

(6) The optical-film wound body according to any one of (1) to (5), wherein the masking film contains an antioxidant.

(7) A method for storing the wound body according to any one of (1) to (6), the method comprising:
storing the optical-film wound body in an environment at 25° C. to 50° C.

(8) A method for producing a substrate film/polarizing plate stacked body, comprising:
a step of obtaining an optical-film wound body of a long-length optical film, the wound body being formed by winding a substrate film/masking film stacked body with a length of 1000 m or more, the substrate film/masking film stacked body being formed by stacking a substrate film and a masking film having a melting peak of 25° C. or higher and 70° C. or lower;
a step of storing the optical-film wound body at 25° C. to 50° C.;
a step of obtaining the substrate film after storage by drawing the substrate film/masking film stacked body from the optical-film wound body and peeling the masking film off the stacked body; and
a step of obtaining the substrate film/polarizing plate stacked body by attaching a polarizing plate to a surface of the substrate film after storage opposite to a surface formerly attached to the masking film, wherein
a peel strength Fi and a peel strength Fo satisfy a relationship of Fi/Fo≧0.3, where
   Fi represents a peel strength of the substrate film/polarizing plate stacked body at an inner wound portion of the optical-film wound body and
   Fo represents a peel strength of the substrate film/polarizing plate stacked body at an outer wound portion of the optical-film wound body.

(9) The method for producing a substrate film/polarizing plate stacked body according to (8), wherein a larger one of the peel strength Fi and the peel strength Fo is 1 to 10 N/15 mm.

(10) The method for producing a substrate film/polarizing plate stacked body according to (8) or (9), wherein the masking film contains an antioxidant.

### Advantageous Effects of Invention

The optical-film wound body of the present invention provides high peel strength with the polarizing plate and maintains high surface quality even after storage for a long period of time as a result of the storage in accordance with the storage method of the present invention.

According to the method for producing a substrate film/polarizing plate stacked body of the present invention, a substrate film/polarizing plate stacked body having high peel strength and high surface quality can be efficiently produced.

### DESCRIPTION OF EMBODIMENTS

Hereinafter, the present invention will be described in detail with reference to embodiments and examples. However, the present invention is not limited to the following embodiments and examples, which may be optionally modified and implemented without departing from the scope of claims of the present invention and the scope of their equivalents.

In the following description, the expression “(meth)acryl-” means to encompass acryl-, methacryl-, and combinations thereof. For example, a (meth)acrylic polymer refers to an acrylic polymer (polymers of acrylic acid, acrylic acid ester, and the like), a methacrylic polymer (polymers of methacrylic acid, methacrylic acid ester, and the like), or any combination thereof.

In the following description, a “long-length” film refers to a film having a length that is 100 or more times its width, and specifically a length to a degree that allows the film to be wound up into a roll shape to be stored or transported. The upper limit of the ratio of the length relative to the width of a film is not particularly limited, and may be equal to or less than 100,000 times.

In the following description, the “polarizing plate” is used as a term which encompasses not only a rigid plate member but also a flexible member like a resin film (including a sheet).

[1. Overview of Wound Body]

The wound body of the present invention is a wound body of a long-length optical-film. The optical-film wound body as used herein refers to an article formed by winding a stacked body of an optical film and another film. The wound body of the present invention is formed by winding a substrate film/masking film stacked body in which a substrate film serving as an optical film and a specific masking film are stacked. As described herein, a stacked body having a structure in which a substrate film and a masking film are stacked may be referred to as a “substrate film/masking film stacked body”. A stacked body having a different structure may also be referred to in a similar manner. For example, a stacked body having a structure in which a substrate film and a polarizing plate are stacked may be referred to as a “substrate film/polarizing plate stacked body”.

[2. Substrate Film]

Examples of the material of the substrate film may include resins containing various types of polymers. Examples of such polymers may include hydrocarbon polymers, (meth)acrylic polymers, and polyesters.

The hydrocarbon polymer refers to a polymer in which at least a part of the repeating units of the polymer is composed of a hydrocarbon group. The ratio of the repeating unit hydrocarbon group in the hydrocarbon polymer may be appropriately selected according to the intended use. The ratio of the hydrocarbon group in the hydrocarbon polymer is preferably 55% by weight or more, more preferably 70% by weight or more, and particularly preferably 90% by weight or more.

As the hydrocarbon polymer, an alicyclic structure-containing polymer is preferable. The alicyclic structure-containing polymer refers to a polymer having an alicyclic structure in the repeating unit of the polymer. The alicyclic structure-containing polymer may be either a polymer having an alicyclic structure in the main chain or a polymer having an alicyclic structure in the side chain. In particular, a polymer containing an alicyclic structure in the main chain is preferable from the viewpoint of mechanical strength, heat resistance, and the like.

Examples of the alicyclic structure may include a saturated alicyclic hydrocarbon (cycloalkane) structure, and an unsaturated alicyclic hydrocarbon (cycloalkene, cycloalkyne) structure. Among these, from the viewpoint of mechanical strength, heat resistance, and the like, a cycloalkane structure and a cycloalkene structure are preferable, and a cycloalkane structure is particularly preferable.

The number of carbon atoms which constitute the alicyclic structure per one alicyclic structure is preferably 4 or more, and more preferably 5 or more, and is preferably 30 or less, more preferably 20 or less, and particularly preferably 15 or less. When the number of carbon atoms falls within this range, mechanical strength, heat resistance, and molding properties of the substrate film can be highly balanced and thus preferred.

The ratio of the repeating unit having an alicyclic structure in the alicyclic structure-containing polymer may be appropriately selected according to the intended use. The ratio of the repeating unit is preferably 55% by weight or more, more preferably 70% by weight or more, and particularly preferably 90% by weight or more. When the ratio of the repeating unit having an alicyclic structure in the alicyclic structure-containing polymer falls within this range, such a ratio is preferable from the viewpoint of the transparency and the heat resistance of the film.

Examples of the alicyclic structure-containing polymer may include a norbornene-based polymer, a monocyclic olefin-based polymer, a cyclic conjugated diene-based polymer, a vinyl alicyclic hydrocarbon polymer, and hydrogenated products thereof. Among these, a norbornene-based polymer may be preferably used as it has favorable transparency and molding properties.

Examples of the norbornene-based polymer may include a ring-opened polymer of a monomer having a norbornene structure, a ring-opened copolymer of a monomer having a norbornene structure and another monomer, and hydrogenation products thereof; and an addition polymer of a monomer having a norbornene structure, an addition copolymer of a monomer having a norbornene structure and another monomer, and hydrogenation products thereof. Among these, a hydrogenation product of a ring-opened (co)polymer of a monomer having a norbornene structure may be particularly suitably used from the viewpoint of, for example, transparency, moldability, heat resistance, low hygroscopicity, size stability, and lightness in weight. The “(co)polymer” refers to a polymer and a copolymer.

Examples of the monomer having a norbornene structure may include bicyclo[2.2.1]hept-2-ene (common name: norbornene), tricyclo[4.3.0.1^{2,5}]dec-3,7-diene (common name: dicyclopentadiene), 7,8-benzotricyclo[4.3.0.1^{2,5}]dec-3-ene (common name: methanotetrahydrofluorene), tetracyclo[4.4.0.1^{2,5}.1^{7,10}]dodeca-3-ene (common name: tetracyclododecene), and derivatives of these compounds (for example, a derivative having a substituent on the ring). Examples of the substituent herein may include an alkyl group, an alkylene group, and a polar group. A plurality of these substituents, which may be the same as or different from each other, may be bonded on the ring. As the monomer having a norbornene structure, one type thereof may be solely used, and two or more types thereof may also be used in combination at any ratio.

Examples of the polar group may include a hetero atom, and an atomic group having a hetero atom. Examples of the hetero atom may include an oxygen atom, a nitrogen atom, a sulfur atom, a silicon atom, and a halogen atom. Specific examples of the polar group may include a carboxyl group, a carbonyloxycarbonyl group, an epoxy group, a hydroxyl group, an oxy group, an ester group, a silanol group, a silyl group, an amino group, a nitrile group, and a sulfonic acid group.

Examples of the optional monomer which is ring-opening copolymerizable with the monomer having a norbornene structure may include: monocyclic olefins such as cyclohexene, cycloheptene, cyclooctene, and derivatives thereof; and cyclic conjugated diene such as cyclohexadiene and cycloheptadiene, and a derivative thereof. As the optional monomer which is ring-opening copolymerizable with the monomer having a norbornene structure, one type thereof may be solely used, and two or more types thereof may also be used in combination at any ratio.

The ring-opened polymer of a monomer having a norbornene structure and the ring-opened copolymer of a monomer having a norbornene structure and another monomer copolymerizable therewith may be obtained by, for example, the polymerization or copolymerization of a monomer in the presence of a publicly known ring-opening polymerization catalyst.

Examples of the optional monomer which is addition copolymerizable with the monomer having a norbornene structure may include: α-olefins having 2 to 20 carbon atoms such as ethylene, propylene, and 1-butene, and derivatives thereof; cycloolefins such as cyclobutene, cyclopentene and cyclohexene, and derivatives thereof; and non-conjugated dienes such as 1,4-hexadiene, 4-methyl-1,4-hexadiene, and 5-methyl-1,4-hexadiene. Among these, α-olefin is preferable, and ethylene is more preferable. As the optional monomer which is addition copolymerizable with the monomer having a norbornene structure, one type thereof may be solely used, and two or more types thereof may also be used in combination at any ratio.

The addition polymer of a monomer having a norbornene structure and the addition copolymer of a monomer having a norbornene structure and another monomer copolymerizable therewith may be obtained by, for example, the polymerization or copolymerization of a monomer in the presence of a publicly known addition polymerization catalyst.

Examples of monocyclic olefin polymers may include an addition polymer of a monocyclic olefin monomer, such as cyclohexene, cyclohepten, or cyclooctene.

Examples of cyclic conjugated diene polymers may include a polymer obtained by the cyclization reaction of an addition polymer of a conjugated diene monomer, such as 1,3-butadiene, isoprene, or chloroprene; a 1,2- or 1,4-addition polymer of a cyclic conjugated diene monomer, such as cyclopentadiene or cyclohexadiene; and hydrogenation products thereof.

Examples of vinyl alicyclic hydrocarbon polymers may include a polymer of a vinyl alicyclic hydrocarbon monomer, such as vinylcyclohexene or vinylcyclohexane, and hydrogenation products thereof; a hydrogenation product formed by hydrogenating an aromatic ring portion in a polymer formed by polymerizing a vinyl aromatic hydrocarbon monomer such as styrene or α-methylstyrene; and a hydrogenation product of an aromatic ring of a vinyl alicyclic hydrocarbon monomer or a copolymer, such as a random copolymer or a block copolymer, of a vinyl aromatic hydrocarbon monomer and another monomer copolymerizable with the vinyl aromatic hydrocarbon monomer. Examples of the aforementioned block copolymer may include diblock copolymers, triblock copolymers, or higher-order multiblock copolymers, and inclined block copolymers.

The molecular weight of the hydrocarbon polymer may be appropriately selected according to the intended use. The molecular weight of the hydrocarbon polymer as the weight-average molecular weight (Mw) determined as the polyisoprene- or polystyrene-equivalent by gel permeation chromatography using cyclohexane as a solvent (toluene may be used when a sample is not dissolved in cyclohexane) is usually 10,000 or higher, preferably 15,000 or higher, and more preferably 20,000 or higher, and is usually 100,000 or lower, preferably 80,000 or lower, and more preferably 50,000 or lower. When the weight-average molecular weight falls within such a range, the film acquires mechanical strength and molding processability in a well-balanced manner, which is preferable.

The molecular weight distribution (weight-average molecular weight (Mw)/number-average molecular weight (Mn)) of the hydrocarbon polymer is usually 1.2 or higher, preferably 1.5 or higher, and more preferably 1.8 or higher, and is usually 3.5 or lower, preferably 3.0 or lower, and more preferably 2.7 or lower. If the molecular weight distribution of the hydrocarbon polymer is higher than 3.5, the amount of low-molecular components increases, and thus the amount of components having a short relaxation time increases, with which, even in the case of a film apparently having the same in-plane retardation Re, the relaxation at the time of exposure to high temperature is supposed to increase in a short time, which may reduce the stability of the film. If the molecular weight distribution is lower than 1.2, productivity for producing the hydrocarbon polymer may be reduced with increased costs.

The glass transition temperature of the hydrocarbon polymer may be appropriately selected according to the intended use. The glass transition temperature of the hydrocarbon polymer is preferably 130° C. or higher, and more preferably 135° C. or higher, and is preferably 150° C. or lower, and more preferably 145° C. or lower. If the glass transition temperature is lower than 130° C., durability at high temperature may be impaired. If the glass transition temperature is higher than 150° C., although durability may be improved, ordinary processing may become difficult.

The absolute value of the photoelastic coefficient of the hydrocarbon polymer is preferably 10×10⁻¹² Pa⁻¹ or less, more preferably 7×10⁻¹² Pa⁻¹ or less, and particularly preferably 4×10⁻¹² Pa⁻¹ or less. The photoelastic coefficient C is a value represented by “C=Δn/σ” where Δn is the birefringence and σ is the stress. If the photoelastic coefficient of the hydrocarbon polymer is more than 10×10⁻¹² Pa⁻¹, there may be wide fluctuations in the front phase difference of the obtained film. The lower limit of the photoelastic coefficient of the hydrocarbon polymer is not particularly limited but may be 1×10⁻¹³ Pa⁻¹ or more.

The saturated water absorption ratio of the hydrocarbon polymer is preferably 0.03% by weight or less, more preferably 0.02% by weight or less, and particularly preferably 0.01% by weight or less. When the saturated water absorption ratio is in the aforementioned range, changes in the front phase difference Re and the thickness direction phase difference Rth of the film with the lapse of time can be kept at low levels. With such a saturated water absorption ratio, deterioration of a polarizing plate and a liquid crystal display device having the obtained substrate film can be reduced, and the display on the screen can be maintained stable and favorable for a long period of time.

The saturated water absorption ratio is a value expressed as the percentage of the weight increase of a test piece after immersion in water at a constant temperature for a certain period of time with respect to the weight of the test piece before immersion. The saturated water absorption is usually measured with the immersion in water at 23° C. for 24 hours. The saturated water absorption ratio of the alicyclic structure-containing polymer may be controlled in the aforementioned region, for example, by reducing the amount of the polar group in the alicyclic structure-containing polymer. The alicyclic structure-containing polymer may preferably have no polar group from the viewpoint of reduction of the saturated water absorption ratio.

The resin that constitutes the substrate film may contain other optional components in addition to a polymer such as an alicyclic structure-containing polymer as long as the advantageous effects of the present invention are not significantly impaired. Examples of optional components may include additives, such as a colorant such as a pigment and a dye; a fluorescent brightening agent; a dispersant; a heat stabilizer; a light stabilizer; an ultraviolet ray absorber; an antistatic agent; an antioxidant; a lubricant; a filler such as talc, stearamide, and calcium stearate; and a nucleating agent. As the optional component, one type thereof may be solely used, and two or more types thereof may also be used in combination at any ratio. The resin that constitutes the substrate film contains usually about 50% to 100%, preferably about 70% to 100% of the polymer such as an alicyclic structure-containing polymer.

The substrate film may be obtained by molding the resin by a publicly known film molding method. The film molding method may be any method for molding a long-length film. Examples thereof may include a cast molding method, an extrusion molding method, and an inflation molding method. In particular, a melt extrusion method wherein a solvent is not used is preferable because thereby the amount of residual volatile components can be efficiently reduced and the method is advantageous from the viewpoint of global environment, work environment, and high production efficiency. Examples of the melt extrusion method may include an inflation method using a die. A method using a T-die is preferable because of superiority in productivity and thickness precision. The film obtained by the melt extrusion method as it is may be used as the substrate film. If necessary, the film may also be subjected to processing such as stretching to form a film having an optical anisotropy before use. Furthermore, optional layers, such as a lubricating layer and an antistatic layer, may be formed on the surface of the obtained film, and the resulting film may be used.

When an unstretched film is stretched to form a substrate film, stretching may be uniaxial stretching which involves stretching only in one direction and may also be biaxial stretching which involves stretching in two different directions. Biaxial stretching may be simultaneous biaxial stretching which involves simultaneous stretching in two directions and may also be sequential biaxial stretching which involves stretching in one direction and subsequent stretching in another direction. Furthermore, stretching may be any of longitudinal stretching which involves stretching in the longitudinal direction of a prestretched film, lateral stretching which involves stretching in the lateral direction of a prestretched film, diagonal stretching which involves stretching in a diagonal direction that is not parallel or perpendicular to the lateral direction of a prestretched film, and combinations thereof. Among these stretching treatments, diagonal stretching is preferable from the viewpoint of easily producing a substrate film having a slow axis that forms an angle of 40° to 50° with respect to at least one side. Examples of the system of stretching may include a roll system, a float system, and a tenter system.

The stretching temperature and the stretching ratio may freely be set in a range wherein a substrate film having a desired in-plane retardation is obtained. Specifically, the stretching temperature is preferably (Tg−30°) C. or higher, and more preferably (Tg−10°) C. or higher, and is preferably (Tg+60°) C. or lower, and more preferably (Tg+50°) C. or lower. The stretching ratio is preferably 1.1 times or more, more preferably 1.2 times or more, and particularly preferably 1.5 times or more, and is preferably 30 times or less, more preferably 10 times or less, and particularly preferably 5 times or less.

The substrate film may have any thickness and may be appropriately controlled so as to have a desired thickness suitable for use as an optical film. Usually, the thickness of the substrate film is preferably 5 μm or more, and more preferably 10 μm or more, and is preferably 50 μm or less, and more preferably 30 μm or less.

[3. Masking Film]

As the material constituting the masking film, a resin is usually used. As such a resin, a resin having characteristics such as heat stability and mechanical strength for protecting the substrate film may be used. In particular, a polymer contained in the resin serving as the material for constituting the masking film may be a homopolymer or copolymer. Suitable examples thereof may include a polyester polymer and a polyolefin polymer. Examples of the polyolefin polymer may include polyethylene, polypropylene, an ethylene-propylene copolymer, a propylene-α-olefin copolymer, an ethylene-α-olefin copolymer, an ethylene-ethyl (meth)acrylate copolymer, an ethylene-methyl (meth)acrylate copolymer, an ethylene-n-butyl (meth)acrylate copolymer, and an ethylene-vinyl acetate copolymer. Examples of the polyethylene may include low-density polyethylene, medium-density polyethylene, high-density polyethylene, and linear low-density polyethylene. Examples of the ethylene-propylene copolymer may include a random copolymer and a block copolymer. Examples of the α-olefin may include butene-1, hexene-1, 4-methylpentene-1, octene-1, pentene-1, and heptene-1. In particular, a film made of a resin containing a polymer of polyethylene or polypropylene is preferable.

In a preferred aspect, the masking film contains an antioxidant. Specifically, the resin that constitutes the masking film preferably contains an antioxidant in addition to the aforementioned polymer of polyethylene or the like.

Examples of the antioxidant may include a phenolic antioxidant and a phosphorus-based antioxidant. Examples of the phenolic antioxidant may include Irganox 1010 and Irganox 1076. Examples of the phosphorus-based antioxidant may include Irgafos 168 and Irgafos P-EPQ. The ratio of the antioxidant contained in the masking film is preferably 0.05% to 0.2%.

The antioxidant contained in the masking film can prevent deterioration of the resin caused by heating during molding. According to a finding by the inventor of the present invention, in a case wherein the masking film that constitutes the optical-film wound body contains the antioxidant, bleeding of the antioxidant reduces peel strength of the substrate film after storage with the polarizing plate attached thereto. In particular, when the masking film is made of a flexible material, an increased contact area between the masking film and the substrate film tends to cause bleeding of the antioxidant. Since such a reduction of the peel strength remarkably occurs in an inner wound portion rather than in an outer wound portion of the wound body, the reduction may become a problem in quality control for the optical-film wound body. According to another finding by the inventor of the present invention, such bleeding of the antioxidant can unexpectedly be reduced by storing the optical-film wound body in particular conditions. Therefore, when the wound body of the present invention is stored by a specific storage method, occurrence of texture transfer can be reduced, and peel strength can also be maintained while enjoying the effect of the antioxidant.

The resin that constitutes the masking film may contain other optional components in addition to the aforementioned antioxidant. Examples of such optional components may include the same as the optional components for the substrate film described above. As the optional component, one type thereof may be solely used, and two or more types thereof may also be used in combination at any ratio. The resin that constitutes the masking film contains usually about 50% to 100%, preferably about 70% to 100% of a polymer as the main component of the resin.

The masking film used in the present invention is formed of a material having a melting peak at 25° C. or higher and 70° C. or lower. As used herein, the melting peak of the material that constitutes the masking film refers to a peak appearing at a temperature lower than the melting point of the resin that is a main component of the material in the graph showing the relationship between temperature and heat flow obtained by subjecting the material to differential scanning calorimetry using a differential scanning calorimeter (for example, “DSC 6220” available from Seiko Instruments Inc.).

The material having such a melting peak may be obtained by appropriately selecting a material having such a melting peak from the aforementioned materials. Since the melting peak may be altered by heat treatment of the material that constitutes the masking film, the melting peak may be adjusted in some cases to a desired value by performing such heat treatment. Specifically, for example, the melting peak may be shifted to a high temperature side by heat treatment of the obtained substrate film/masking film stacked body before winding. When such shift is preferable, winding may be performed after such heat treatment. According to a finding by the inventor of the present invention, a material having such a melting peak is a flexible film and can reduce occurrence of texture transfer.

The masking film used in the present invention is preferably a flexible film. The “flexible” masking film as used herein refers to a masking film having a Young's modulus (determined according to JIS K7127) of 100 MPa or less. The lower limit of the Young's modulus of the flexible film is not particularly limited but may be, for example, 20 MPa or more. By employing such a flexible film as a masking film, the masking film functions as a cushion. Consequently, deformation of the masking film can absorb unevenness of the substrate film to reduce occurrence of texture transfer. Even if wrinkles and slacks are generated during winding together with the substrate film, these wrinkles and slacks can be reduced by pulling the masking film with a relatively weak force.

Although the masking film may have any thickness, the thickness is usually 5 μm or more, usually 500 μm or less, preferably 300 μm or less, and more preferably 150 μm or less.

[4. Substrate Film/Masking Film Stacked Body and Production of Wound Body]

The substrate film/masking film stacked body may be obtained by stacking the aforementioned substrate film and masking film. Usually, such a stacking process may be performed continuously by staking a long-length substrate film and a long-length masking film with the longitudinal directions thereof aligned, and subjecting these films to pressurizing treatment with a pair of rolls for effecting pressure bonding. The obtained substrate film/masking film stacked body is wound to obtain an optical-film wound body. These stacking and winding processes may be performed continuously in a production line.

The substrate film/masking film stacked body has a long-length shape with a length of 1,000 m or more. Use of a long-length stacked body enables efficient production of an optical film. The upper limit of the length is not particularly limited but may be, for example, 10,000 m or less. The width of the substrate film/masking film stacked body is preferably 500 mm or more, and more preferably 1,000 mm or more, and is preferably 2,500 mm or less, and more preferably 2,000 mm or less.

[5. Storage]

The optical-film wound body of the present invention is preferably stored by a specific storage method for a period of time after production until the substrate film is attached to the polarizing plate. This storage method will be described below as the storage method of the present invention.

In the method for storing the optical-film wound body of the present invention, the optical-film wound body of the present invention is stored in an environment at a specific temperature. The storage temperature is usually 25° C. or higher, and preferably 30° C. or higher, and is 50° C. or lower, and preferably 48° C. or lower. The storage at this temperature may be carried out by, for example, placing the wound body in a chamber or container in which the temperature is controlled at the aforementioned temperature. According to a finding by the inventor of the present invention, an unexpected effect of suppressing a reduction in peel strength is obtained by storing the optical-film wound body of the present invention in an environment at such a specific temperature, even when compared to a case wherein the optical-film wound body is stored, for example, at a low temperature of 20° C. In particular, when a masking film containing an antioxidant is used, storage in an environment at such a specific temperature can reduce bleeding of the antioxidant and can particularly effectively suppress a reduction in peel strength. Therefore, when the optical-film wound body of the present invention is stored by the storage method of the present invention, occurrence of texture transfer can be reduced, and peel strength can also be maintained while enjoying the effect of the antioxidant.

In the method for storing the optical-film wound body of the present invention, the storing in an environment at the aforementioned specific temperature is performed for a part of or the entire period of time after the substrate film/masking film stacked body is wound to form a wound body until the substrate film/masking film stacked body is drawn from the wound body. It is preferable that the storing in an environment at the aforementioned specific temperature is performed in a period of time that is 50% to 100% of the period of time from winding to drawing.

The storage period may be set to any period as long as the production of the optical-film wound body and the production of the substrate film/polarizing plate stacked body using the optical-film wound body can be conveniently carried out. According to the storage method of the present invention, the substrate film/polarizing plate stacked body with good quality may be produced even after storage, for example, for 24 hours or longer or for 48 hours or longer. The upper limit of the storage period is not particularly limited but may be, for example, 90 days or shorter or 100 days or shorter.

[6. Method for Producing Substrate Film/Polarizing Plate Stacked Body]

The method for producing a substrate film/polarizing plate stacked body of the present invention may include a step of obtaining the optical-film wound body of the present invention, a step of storing the optical-film wound body by the method for storing the present invention, a step of obtaining the substrate film after storage by drawing a substrate film/masking film stacked body from the optical-film wound body and peeling a masking film off the stacked body, and a step of stacking the substrate film after storage and the polarizing plate.

It is usually preferable that the substrate film after storage has high transparency in order to exert the function as an optical member. Specifically, the total light transmittance of the film is preferably 80% or higher, and more preferably 90% or higher. The total light transmittance is the average value of the total light transmittance values measured at three points using a “turbidity meter NDH-2000” available from Nippon Denshoku Industries Co., Ltd. according to JIS K7105. The optical film having such a high transparency may be obtained by appropriately selecting a material of a thermoplastic resin.

It is usually preferable that the substrate film has a small haze. Specifically, the haze of the film is preferably 5% or less, more preferably 3% or less, and particularly preferably 2% or less. When an optical film is incorporated into, for example, a display device, a low haze of the film results in improved clearness of images on the display device. The haze may be determined with a turbidity meter “NDH2000” available from Nippon Denshoku Industries Co., Ltd.

Stacking of the substrate film after storage and the polarizing plate may be performed by stacking the long-length substrate film and the long-length polarizing plate with the longitudinal directions thereof aligned such that these films are attached. Alternatively, the substrate film after storage may be cut in a suitable size, and the cut substrate film may then be attached to a polarizing plate having a size that matches the size of the substrate film.

In stacking the substrate film and the polarizing plate, the surface of the substrate film opposite to the surface formerly attached to the masking film is attached to the polarizing plate in order to achieve favorable attachment between the substrate film and the polarizing plate.

In stacking the substrate film after storage and the polarizing plate, an adhesive layer may be interposed between the substrate film and the polarizing plate if necessary. When the adhesive is of a type requiring irradiation with energy rays such as ultraviolet rays for curing, such irradiation may be carried out after attachment if necessary, to obtain a substrate film/polarizing plate stacked body.

Examples of the polarizing plate for use may include a known polarizer that has been used for devices such as liquid crystal display devices and other optical devices, and a stacked body including the polarizer and a protective film for protecting the polarizer. The polarizer may be a linear polarizer. Alternatively, the polarized may also be a circular polarizer that selectively transmits a specific circularly polarized light.

Examples of the linear polarizer may include a linear polarizer obtained by causing iodine or a dichromatic dye to be adsorbed onto a polyvinyl alcohol film and then uniaxially stretching the film in a boric acid bath; and a linear polarizer obtained by causing iodine or a dichromatic dye to be adsorbed onto a polyvinyl alcohol film, then stretching the film, and converting some of polyvinyl alcohol units in the molecular chains into polyvinylene units. Other examples of the linear polarizer may include polarizers having a function of splitting polarized light into reflected light and transmitted light, such as a grid polarizer, a multilayer polarizer, and a cholesteric liquid crystal polarizer. Among these, a polarizer containing polyvinyl alcohol is preferable. The degree of polarization of the polarizer used in the present invention is not particularly limited, but it is preferably 98% or more, and more preferably 99% or more. The average thickness of the polarizer is preferably 5 to 80 μm.

[7. Peel Strength]

In the substrate film/polarizing plate stacked body obtained by the method for producing a substrate film/polarizing plate stacked body of the present invention, the peel strength between the substrate film and the polarizing plate is preferably 1 to 10 N/15 mm.

The measurement of the peel strength may be performed by fixing the substrate film-side surface of the substrate film/polarizing plate stacked body onto a suitable flat stage; and carrying out a 90-degree peel test by pulling the polarizing plate in the normal direction of the surface of the stage using a force gauge (for example, “Digital Force Gauge” available from IMADA Co., Ltd.) to measure the force measured when the polarizing plate is peeled off.

In the substrate film/polarizing plate stacked body obtained by the method for producing a substrate film/polarizing plate stacked body of the present invention, the peel strength at the inner wound portion may be different from that at the outer wound portion. The peel strength at the inner wound portion is defined as a peel strength with a portion of the substrate film that corresponds to a position 500 m distant from the outer wound end when the portion was in the wound body. The peel strength at the outer wound portion is defined as a peel strength with a portion of the substrate film that corresponds to a position 3 m distant from the outer wound end when the portion was in the wound body. When the peel strength at the inner wound portion is different from that at the outer wound portion, the higher one of the peel strengths is preferably 1 to 10 N/15 mm.

In the substrate film/polarizing plate stacked body obtained by the method for producing a substrate film/polarizing plate stacked body of the present invention, a peel strength Fi and a peel strength Fo satisfy the relationship of Fi/Fo≧0.3, where Fi represents a peel strength of the substrate film/polarizing plate stacked body at the inner wound portion of the optical-film wound body, and Fo represents a peel strength of the substrate film/polarizing plate stacked body at the outer wound portion of the optical-film wound body. In other words, the peel strength Fi at the inner wound portion is 30% or more of the peel strength Fo at the outer wound portion (in the following description, the ratio of the inner wound peel strength Fi relative to the outer wound peel strength Fo in percentage terms may be referred to simply as an “inner/outer wound peel strength ratio”). The inner/outer wound peel strength ratio is preferably 30% or higher, and more preferably 50% or higher. The upper limit is not particularly limited but usually 100% or less. According to a finding by the inventor of the present invention, the inner wound peel strength has a higher tendency to decrease than the outer wound peel strength, but the ratio of a decrease in inner wound peel strength relative to a decrease in outer wound peel strength can be reduced by using the specific optical-film wound body described above and further employing the specific storage method described above. In particular, when the masking film contains an antioxidant, the tendency of causing bleeding of the antioxidant on both the surface of the masking film attached to the substrate film and on the surface of the other side of the masking film is higher particularly in the inner wound portion that receives higher pressure in the wound body. Because of this, particularly the inner wound peel strength tends to decrease. In this situation, employment of the specific optical-film wound body and the storage method described above increases the inner wound peel strength and further increases the inner/outer wound peel strength ratio.

With the optical-film wound body of the present invention, a peel strength Fi and a peel strength Fo satisfy the relationship of Fi/Fo≧0.3, where Fi represents the peel strength obtained in a case where a surface of the substrate film corresponding to the substrate film/masking film stacked body at the inner wound portion of the optical-film wound body, the surface being opposite to the surface attached to the masking film, is attached to the polarizing plate, and Fo represents the peel strength obtained in a case where a surface of the substrate film corresponding to the substrate film/masking film stacked body at the outer wound portion of the optical-film wound body, the surface being opposite to the surface attached to the masking film, is attached to the polarizing plate. Furthermore, the larger one of the peel strengths Fi and Fo is preferably 1 to 10 N/15 mm. The peel strength in this case is evaluated using HLC2-5618S (available from Sanritz Corporation) as a polarizing plate.

[8. Application of Substrate Film/Polarizing Plate Stacked Body] The application of the substrate film/polarizing plate stacked body obtained by the method for producing a substrate film/polarizing plate stacked body of the present invention is not particularly limited. The substrate film/polarizing plate stacked body may be used as a component in display devices, such as liquid crystal display devices and organic electroluminescence display devices, other optical devices, and the like.

### EXAMPLES

Hereinafter, the present invention will be specifically described by illustrating Examples. However, the present invention is not limited to the following Examples, and may be freely modified and practiced without departing from the scope of claims and the scope of their equivalents.

In the following description, the operation was performed at a normal temperature and normal pressure, unless otherwise stated.

(Method for Evaluating Melting Peak)

The melting peak of the masking film was measured with a differential scanning calorimeter (“DSC 6220” available from Seiko Instruments Inc.). The conditions were a sample weight of 10 mg and a heating rate of 2° C./min.

(Method for Evaluating Peel Strength)

The substrate film-side surface of the substrate film/polarizing plate stacked body having a layer structure of (polarizing plate)/(adhesive layer)/(substrate film) obtained in each of Examples and Comparative Examples was attached to the surface of a slide glass using an adhesive and a laminator. As the adhesive, a double-sided adhesive tape (product number “CS9621” available from Nitto Denko Corporation) was used.

The 90-degree peel test was carried out by pinching the polarizing plate at the tip of a force gauge (“Digital Force Gauge” available from IMADA Co., Ltd.) and pulling the polarizing plate in the normal direction of the surface of the slide glass. At this time, the force measured when the polarizing plate was peeled off was a force required to separate the substrate film and the polarizing film, and the magnitude of this force was measured as the peel strength.

(Texture Transfer)

The degree of texture transfer was evaluated for inner wound samples of the substrate film after storage among inner wound samples and outer wound samples obtained in Examples and Comparative Examples. The reflection of a fluorescent lamp light on the substrate film was visually evaluated. Samples for which there was no change in the shape of the fluorescent lamp were rated “A”, samples for which the edge of the fluorescent lamp was deformed were rated “B”, and samples for which the fluorescent lamp was entirely distorted were rated “C”.

### Example 1

### 1-1. Masking Film

As a masking film, a long-length film formed of a film (trade name “Tretec” available from Toray Advanced Film Co., Ltd.) including polyethylene and an antioxidant was prepared. This film was a flexible film and had a melting peak of 45° C.

### 1-2. Substrate Film

A diagonally stretched film made of a cycloolefin polymer was prepared as a substrate film. This substrate film was a stretched film prepared by stretching a long-length film made of a cycloolefin polymer (trade name “ZEONOR Film ZF14-040” available from ZEON Corporation) at a degree of 45° with respect to the film short-side direction at a stretching ratio of 1.5 times. The thickness of the substrate film was 25 μm.

### 1-3. Attachment and Winding

The masking film obtained in (1-1) was attached to the substrate film obtained in (1-2) with the longitudinal directions thereof aligned, to form a substrate film/masking film stacked body having a width of 1,330 mm and a length of 1,000 m, which was wound to form a long-length wound body.

### 1-4. Storage of Wound Body

The wound body obtained in (1-3) was stored at 40° C. for one day.

### 1-5. Polarizing Plate Stacked Body

The substrate film after storage was obtained by drawing the substrate film/masking film stacked body from the wound body obtained in (1-4) and peeling the masking film off the stacked body. An outer wound sample was obtained by cutting the substrate film in a size of 15 mm×200 mm at a position 3 m distant from the outer wound end of the substrate film such that the widthwise direction of the substrate film corresponded to the longitudinal direction of the sample. An inner wound sample was obtained by cutting the substrate film in a size of 15 mm×200 mm at a position 500 m distant from the outer wound end of the substrate film such that the widthwise direction of the substrate film corresponded to the longitudinal direction of the sample.

The degree of texture transfer in the inner wound sample was rated as “A”.

One surface of each sample of the obtained substrate film (the surface opposite to the surface formerly attached to the masking film) was subjected to a corona treatment. The corona treatment was carried out in a treatment condition of 150 W·min/m² using a corona treatment device (available from Kasuga Electric Works Ltd.).

A polarizing plate (HLC2-5618S (available from Sanritz Corporation)) was prepared, and one surface of the polarizing plate was subjected to a corona treatment. The corona treatment was carried out using the same device as in the corona treatment for samples of the substrate film. The treatment condition was 750 W·min/m².

An adhesive was applied onto the corona-treated surface of the polarizing plate with a bar coater to form an adhesive layer. As the adhesive, a UV adhesive was used. The adhesive layer-side surface of the polarizing plate was attached to the corona-treated surface of the sample of the substrate film. The resulting stacked body was irradiated with ultraviolet rays from the substrate film side to obtain a polarizing plate stacked body having a layer structure of (polarizing plate)/(adhesive layer)/(substrate film).

### 1-6. Evaluation of Peel Strength

The peel strength test of this polarizing plate stacked body was performed. As a result, the peel strength Fo of the outer wound sample was 1.705 N/15 mm, while the peel strength Fi of the inner wound sample was 1.517 N/15 mm. The inner/outer wound peel strength ratio was 89%.

### Example 2

A polarizing plate stacked body was obtained and evaluated in the same manner as in Example 1 except that, in (1-3), the substrate film/masking film stacked body was passed through an oven at 50° C. for 2 minutes after the substrate film/masking film stacked body was obtained and before this stacked body was wound to form a wound body. The masking film was taken out from a part of the stacked body after the stacked body was passed through the oven. The melting peak of the masking film was measured and found to be 55° C.

As a result of the peel strength test, the peel strength Fo of the outer wound sample was 1.705 N/15 mm, while the peel strength Fi of the inner wound sample was 1.14 N/15 mm. The inner/outer wound peel strength ratio was 67%. The degree of texture transfer of the inner wound sample was rated “A”.

### Example 3

A polarizing plate stacked body was obtained and evaluated in the same manner as in (1-2) to (1-6) in Example 1 except that, in place of the substrate film prepared in (1-1), a uniaxially laterally stretched film made of a cycloolefin polymer (available from ZEON Corporation, Tg 126° C.) was used. As a result, the peel strength Fo of the outer wound sample was 0.3 N/15 mm, while the peel strength Fi of the inner wound sample was 0.12 N/15 mm. The inner/outer wound peel strength ratio was 40%. The degree of texture transfer of the inner wound sample was rated “A”.

### Example 4

A polarizing plate stacked body was obtained and evaluated in the same manner as in (1-2) to (1-6) in Example 1 except that, in place of the substrate film prepared in (1-1), an unstretched film made of a cycloolefin polymer (available from ZEON Corporation, Tg 140° C.) was used. As a result, the peel strength Fo of the outer wound sample was 9.5 N/15 mm, while the peel strength Fi of the inner wound sample was 3.24 N/15 mm. The inner/outer wound peel strength ratio was 34%. The degree of texture transfer of the inner wound sample was rated “A”.

### Example 5

A polarizing plate stacked body was obtained and evaluated in the same manner as in Example 1 except that the storage temperature of the wound body was changed from 40° C. to 50° C. in the storage step (1-4). As a result, the peel strength Fo of the outer wound sample was 1.705 N/15 mm, while the peel strength Fi of the inner wound sample was 1.09 N/15 mm. The inner/outer wound peel strength ratio was 64%. The degree of texture transfer of the inner wound sample was rated “A”.

### Comparative Example 1

A polarizing plate stacked body was obtained in the same manner as in Example 1 except that, in (1-3), the substrate film/masking film stacked body was passed through an oven at 80° C. for 2 minutes after the substrate film/masking film stacked body was obtained and before this stacked body was wound to form a wound body. The masking film was taken out from a part of the stacked body after the stacked body was passed through the oven. The melting peak of the masking film was measured and found to be 74° C.

As a result of the peel strength test, the peel strength Fo of the outer wound sample was 1.705 N/15 mm, while the peel strength Fi of the inner wound sample was 0.385 N/15 mm. The inner/outer wound peel strength ratio was 23%. The degree of texture transfer of the inner wound sample was rated “A”.

### Comparative Example 2

A polarizing plate stacked body was obtained and evaluated in the same manner as in Example 1 except that the storage temperature of the wound body was changed from 40° C. to 60° C. in the storage step (1-4). As a result, the peel strength Fo of the outer wound sample was 1.705 N/15 mm, while the peel strength Fi of the inner wound sample was 0.113 N/15 mm. The inner/outer wound peel strength ratio was 7%. The degree of texture transfer of the inner wound sample was rated “A”.

### Reference Example 1

A polarizing plate stacked body was obtained and evaluated in the same manner as in Example 1 except for the following changes.
As the masking film, a commercially available masking film (trade name “Force Field 1035” available from Tredegar Film Products Corporation, a polyethylene film, thickness 27 μm, width 1330 mm) was used in place of the film prepared in (1-1). This masking film was not flexible. Evaluation of the melting peak of the masking film was performed. As a result, there was no melting peak.
The storage temperature of the wound body was changed from 40° C. to 25° C. in the storage step (1-4).

As a result, the peel strength Fo of the outer wound sample was 3.09 N/15 mm, while the peel strength Fi of the inner wound sample was 2.49 N/15 mm. The inner/outer wound peel strength ratio was 81%. The degree of texture transfer of the inner wound sample was rated “C”.

### Reference Example 2

A polarizing plate stacked body was obtained and evaluated in the same manner as in Example 1 except for the following changes.
As the masking film, a commercially available masking film (trade name “Force Field 1035”), which was the same as that used in Reference Example 1, was used in place of the film prepared in (1-1).
The storage temperature of the wound body was changed from 40° C. to 60° C. in the storage step (1-4).

As a result, the peel strength Fo of the outer wound sample was 3.09 N/15 mm, while the peel strength Fi of the inner wound sample was 1.79 N/15 mm. The inner/outer wound peel strength ratio was 58%. The degree of texture transfer of the inner wound sample was rated “C”.

The results of Examples, Comparative Examples, and Reference Examples are summarized in Tables 1 and 2.

TABLE 1

| | Ex. 1 | Ex. 2 | Ex. 3 | Ex. 4 | Ex. 5 |
|---|---|---|---|---|---|
| Substrate | A | A | B | C | A |
| film*1 | | | | | |
| Masking | A | A | A | A | A |
| film*2 | | | | | |
| Melting peak | 45 | 55 | 45 | 45 | 45 |
| temperature | | | | | |
| (° C.) | | | | | |
| Outer wound | 1.705 | 1.705 | 0.3 | 9.5 | 1.705 |
| peel strength | | | | | |
| Fo(N/15 mm) | | | | | |
| Inner wound | 1.517 | 1.14 | 0.12 | 3.2 | 1.09 |
| peel strength | | | | | |
| Fi(N/15 mm) | | | | | |
| Inner/outer | 89% | 67% | 40% | 34% | 64% |
| wound peel | | | | | |
| strength | | | | | |
| ratio | | | | | |
| Storage | 40 | 40 | 40 | 40 | 50 |
| temperature | | | | | |
| (° C.) | | | | | |
| Texture | A | A | A | A | A |
| transfer | | | | | |

TABLE 2

| | Comp. | Comp. | Ref. | |
|---|---|---|---|---|
| | Ex. 1 | Ex. 2 | Ex. 1 | Ref. Ex. 2 |
| Substrate | A | A | A | A |
| film*1 | | | | |
| Masking | A | A | B | B |
| film*2 | | | | |
| Melting | 74 | 45 | — | — |
| peak | | | | |
| temperature | | | | |
| (° C.) | | | | |
| Outer wound | 1.705 | 1.705 | 3.09 | 3.09 |
| peel | | | | |
| strength | | | | |
| Fo (N/15 mm) | | | | |
| Inner wound | 0.385 | 0.113 | 2.49 | 1.79 |
| peel | | | | |
| strength | | | | |
| Fi (N/15 mm) | | | | |
| Inner/outer | 23% | 7% | 81% | 58% |
| wound peel | | | | |
| strength | | | | |
| ratio | | | | |
| Storage | 40 | 60 | 25 | 60 |
| temperature | | | | |
| (° C.) | | | | |
| Texture | A | A | C | C |
| transfer | | | | |

*1 Substrate film, A: a diagonally stretched film made of a cycloolefin polymer, B: a uniaxially laterally stretched film made of a cycloolefin polymer, C: an unstretched film made of a cycloolefin polymer, D: a uniaxially laterally stretched film made of a cycloolefin polymer

*2 Masking film, A: trade name “Tretec” available from Toray Advanced Film Co., Ltd., B: a film having no melting peak (trade name “Force Field 1035” available from Tredegar Film Products Corporation)

The results of Examples and Comparative Examples indicate that the optical-film wound body of the present invention provides high peel strength with the polarizing plate and maintains high surface quality even after storage for a long period of time as a result of the storage in accordance with the storage method of the present invention, and therewith a substrate film/polarizing plate stacked body having high quality can be efficiently produced.

1. An optical-film wound body of a long-length optical film, formed by winding a substrate film/masking film stacked body with a length of 1,000 m or more, the substrate film/masking film stacked body being formed by stacking a substrate film and a masking film, wherein
the masking film is formed of a material having a melting peak of 25° C. or higher and 70° C. or lower, and
a peel strength Fi and a peel strength Fo satisfy a relationship of Fi/Fo≧0.3, where
Fi represents a peel strength obtained in a case where a surface of the substrate film corresponding to the substrate film/masking film stacked body at an inner wound portion of the optical-film wound body, the surface being opposite to a surface attached to the masking film, is attached to a polarizing plate, and
Fo represents a peel strength obtained in a case where a surface of the substrate film corresponding to the substrate film/masking film stacked body at an outer wound portion of the optical-film wound body, the surface being opposite to a surface attached to the masking film, is attached to a polarizing plate.

2. The optical-film wound body according to claim 1, wherein a larger one of the peel strength Fi and the peel strength Fo is 1 to 10 N/15 mm.

3. The optical-film wound body according to claim 1, wherein the substrate film of the wound body is a stretched film.

4. The optical-film wound body according to claim 1, wherein the substrate film is a film made of a resin containing an alicyclic structure-containing polymer.

5. The optical-film wound body according to claim 1, wherein the masking film is a film made of polyethylene.

6. The optical-film wound body according to claim 1, wherein the masking film contains an antioxidant.

7. A method for storing the wound body according to claim 1, the method comprising:
storing the optical-film wound body in an environment at 25° C. to 50° C.

8. A method for producing a substrate film/polarizing plate stacked body, comprising:
a step of obtaining an optical-film wound body of a long-length optical film, the wound body being formed by winding a substrate film/masking film stacked body with a length of 1000 m or more, the substrate film/masking film stacked body being formed by stacking a substrate film and a masking film having a melting peak of 25° C. or higher and 70° C. or lower;
a step of storing the optical-film wound body at 25° C. to 50° C.;
a step of obtaining the substrate film after storage by drawing the substrate film/masking film stacked body from the optical-film wound body and peeling the masking film off the stacked body; and
a step of obtaining the substrate film/polarizing plate stacked body by attaching a polarizing plate to a surface of the substrate film after storage opposite to a surface formerly attached to the masking film, wherein
a peel strength Fi and a peel strength Fo satisfy a relationship of Fi/Fo≧0.3, where
Fi represents a peel strength of the substrate film/polarizing plate stacked body at an inner wound portion of the optical-film wound body and
Fo represents a peel strength of the substrate film/polarizing plate stacked body at an outer wound portion of the optical-film wound body.

9. The method for producing a substrate film/polarizing plate stacked body according to claim 8, wherein a larger one of the peel strength Fi and the peel strength Fo is 1 to 10 N/15 mm.

10. The method for producing a substrate film/polarizing plate stacked body according to claim 8, wherein the masking film contains an antioxidant.
